(19) United States
(12) Patent Application Publication
(10) Pub. No.: US 2015/0185410 A1
(43) Pub. Date: Jul. 2, 2015

(54) BACKLIGHT ASSEMBLY AND DISPLAY INCLUDING THE SAME

(71) Applicant: SAMSUNG DISPLAY CO., LTD,, Yongin-City (KR)

(72) Inventors: Dae Hoon SONG, Seoul (KR); Seul Gi KIM, Seoul (KR); Sang Hyuck YOON, Seoul (KR)

(73) Assignee: SAMSUNG DISPLAY CO., LTD,, Yongin-City (KR)

(21) Appl. No.: 14/263,190

(22) Filed: Apr. 28, 2014

(30) Foreign Application Priority Data
Dec. 27, 2013 (KR) 10-2013-0165546

(51) Int. Cl. F21V 8/00; G02F 1/1335

(52) U.S. Cl. CPC G02B 6/0091; G02B 6/0073; G02B 6/0026; G02B 6/0031; G02B 6/0068; G02F 1/133615

(57) ABSTRACT

A backlight assembly includes a light source portion configured to emit light and a wavelength conversion member disposed on an upper portion of the light source portion. The wavelength conversion member is configured to convert a wavelength of the light emitted from the light source portion. A light guide plate is disposed on a side portion of the wavelength conversion member. The light guide plate is configured to receive wavelength-converted light from the wavelength conversion member.

### CROSS-REFERENCE TO RELATED APPLICATION

This application claims priority under 35 U.S.C. §119 to Korean Patent Application No. 10-2013-0165546, filed on Dec. 27, 2013 in the Korean Intellectual Property Office, the disclosure of which is incorporated by reference herein in its entirety.

### 1. TECHNICAL FIELD

Exemplary embodiments of the present invention relate to a display device, and more particularly to a backlight assembly and a display device including the same.

### 2. DISCUSSION OF RELATED ART

A display device may display data. A display device may be a liquid crystal display, an electrophoretic display, an organic light emitting display, an inorganic electroluminescent (EL) display, a field emission display, a surface-conduction electron-emitter display, a plasma display, or a cathode ray display, for example.

A liquid crystal display may include a liquid crystal layer arranged between two transparent substrates, and light permeability for each pixel may be adjusted according to a driving voltage applied to the liquid crystal layer to display a desired image.

A light source may be installed in the liquid crystal display, and contrast may be implemented by adjusting the strength of light that passes through the liquid crystals installed in each pixel. A backlight assembly including a light source portion may determine picture quality, such as luminance and uniformity of the liquid crystal device.

The backlight assembly may include a light source portion, a reflective plate, a diffusion plate, a light guide plate, and various optical plates. A backlight assembly may be a direct type or an edge type depending on the position of the light source portion. The direct type backlight assembly may include the light source portion that is arranged to face the lower surface of the diffusion plate. The edge type backlight assembly may include the light source portion that is arranged to face the side surface of the light guide plate.

Edge type backlight assemblies may be used in thin liquid crystal displays. An edge type backlight assembly, a light source portion and a light guide plate may be disposed on the same plane. If the light guide plate receives heat and expands, the light source portion may be damaged by the expanded light guide plate. If an expansion prevention structure is installed between the light source portion and the light guide plate to prevent the damage of the light source portion, the light source portion can be prevented from being damaged by the expansion of the light guide plate, but a dark portion may be generated in the expansion prevention structure.

### SUMMARY

According to exemplary embodiments of the present invention, a backlight assembly may be provided which prevents damage to a light source portion due to thermal expansion of a light guide plate and increases color purity and uniformity of light that is transferred to the light guide plate.

According to exemplary embodiments of the present invention, a display device may be provided, which prevents damage to a light source portion due to thermal expansion of a light guide plate and increases color purity and uniformity of light that is transferred to the light guide plate.

According to an exemplary embodiment of the present invention, a backlight assembly includes a light source portion configured to emit light, and a wavelength conversion member disposed on an upper portion of the light source portion. The wavelength conversion member is configured to convert a wavelength of the light emitted from the light source portion. A light guide plate is disposed on a side portion of the wavelength conversion member. The light guide plate is configured to receive wavelength-converted light incident from the wavelength conversion member.

The wavelength conversion member may include quantum dots.

The wavelength conversion member may include a reflective layer configured to reflect the light emitted from the light source portion in a direction of the light guide plate. A wavelength conversion layer is disposed on a surface of the reflective layer. The surface of the reflective layer faces the light source portion and the light guide plate.

The surface of the reflective layer forms an angle with a light emission surface of the light source portion.

The angle of the surface of the reflective layer is about 20° to about 70°.

The backlight assembly may include a mold frame disposed on an upper portion of the wavelength conversion member. The mold frame may include an inclined surface that forms an angle with a light emission surface of the light source portion. The wavelength conversion member may be disposed on the inclined surface.

The light source portion may include a plurality of light sources that are spaced apart from each other. A plurality of wavelength conversion members respectively correspond to the plurality of light sources.

The light guide plate may include a projection portion projecting in a direction of the wavelength conversion member.

An upper surface of the projection portion may be substantially parallel to a surface of the wavelength conversion member. A lower surface of the projection portion may be substantially parallel to a light emission surface of the light source portion.

According to an exemplary embodiment of the present invention, a backlight assembly includes a light source portion configured to emit light, and a wavelength conversion member disposed on an upper portion of the light source portion. The wavelength conversion member is configured to convert a wavelength of the light emitted from the light source portion. A mold frame is disposed on an upper portion of the wavelength conversion member. The mold frame is configured to reflect the wavelength-converted light from the wavelength conversion member. A light guide plate is disposed on a side portion of the mold frame. The light guide plate is configured to receive the light that is reflected by the mold frame.

The wavelength conversion member may include a wavelength conversion layer including quantum dots, and a sealing member sealing the wavelength conversion layer.

The backlight assembly may include a support disposed between the light source portion and the wavelength conversion member. The support may fix the wavelength conversion member.

The light source portion may include a circuit board and a light source positioned on the circuit board. The support may surround the light source.

The mold frame may include an inclined surface that forms an angle with a light emission surface of the light source portion. The inclined surface may be disposed on the upper portion of the wavelength conversion member and a side portion of the light guide plate.

The angle of the mold frame may be about 20° to about 70°.

The light source portion may include a plurality of light sources that are spaced apart from each other. A plurality of wavelength conversion members may respectively correspond to the plurality of light sources.

The light guide plate may include a projection portion projecting in a direction of the mold frame.

According to an exemplary embodiment of the present invention, a display device includes a display panel configured to display an image. A backlight assembly is configured to provide light to the display panel. The backlight assembly includes a light source portion configured to emit light, and a wavelength conversion member disposed on an upper portion of the light source portion. The wavelength conversion member is configured to convert a wavelength of the light emitted from the light source portion. A light guide plate is disposed on a side portion of the wavelength conversion member. The light guide plate is configured to receive the wavelength-converted light from the wavelength conversion member.

The wavelength conversion member may include quantum dots.

The wavelength conversion member may include a reflective layer configured to reflect the light emitted from the light source portion in a direction of the light guide plate. A wavelength conversion layer may be disposed on a surface of the reflective layer. The surface of the reflective layer may face the light source portion and the light guide plate.

### BRIEF DESCRIPTION OF THE DRAWINGS

The above and other features of the present invention will become more apparent by describing in detail exemplary embodiments thereof, with reference to the accompanying drawings in which:

FIG. 1 is a cross-sectional view of a display device according to an exemplary embodiment of the present invention;

FIG. 2 is an enlarged cross-sectional view of a portion II in FIG. 1;

FIG. 3 is a perspective view of a backlight assembly of the display device of FIG. 1;

FIG. 4 is a cross-sectional view illustrating an expanded light guide plate in the display device of FIG. 1;

FIGS. 5 and 6 are graphs illustrating color coordinates in a portion A-B in the case where a horizontal light incident structure is applied to the backlight assembly of FIG. 3;

FIGS. 7 and 8 are graphs illustrating color coordinates in a portion A-B of FIG. 3;

FIG. 9 is a perspective view of a backlight assembly of a display device according to an exemplary embodiment of the present invention;

FIG. 10 is a cross-sectional view of a display device according to an exemplary embodiment of the present invention;

FIG. 11 is a cross-sectional view of a display device according to an exemplary embodiment of the present invention;

FIG. 12 is an enlarged cross-sectional view of a portion XII in FIG. 11;

FIG. 13 is a perspective view of a backlight assembly of the display device of FIG. 11;

FIG. 14 is a cross-sectional view illustrating an expanded light guide plate in the display device of FIG. 11;

FIG. 15 is a perspective view of a backlight assembly of a display device according to an exemplary embodiment of the present invention; and

FIG. 16 is a cross-sectional view of a display device according to an exemplary embodiment of the present invention.

### DETAILED DESCRIPTION OF THE EMBODIMENTS

The present invention and methods of accomplishing the same may be better understood by reference to the following detailed description of exemplary embodiments and the accompanying drawings. The present invention may, however, be embodied in many different forms and should not be construed as being limited to the exemplary embodiments set forth herein. Like numbers may refer to like elements throughout. In the drawings, the thickness of layers and regions may be exaggerated for clarity.

It will be understood that when an element or layer is referred to as being “on” or “connected to” another element or layer, it may be directly on or connected to the other element or layer or intervening elements or layers may be present.

Hereinafter, exemplary embodiments of the present invention will be described in more detail with reference to the accompanying drawings.

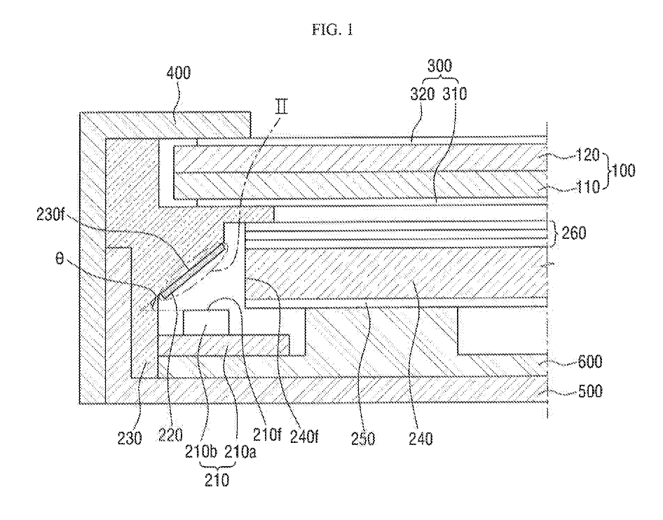

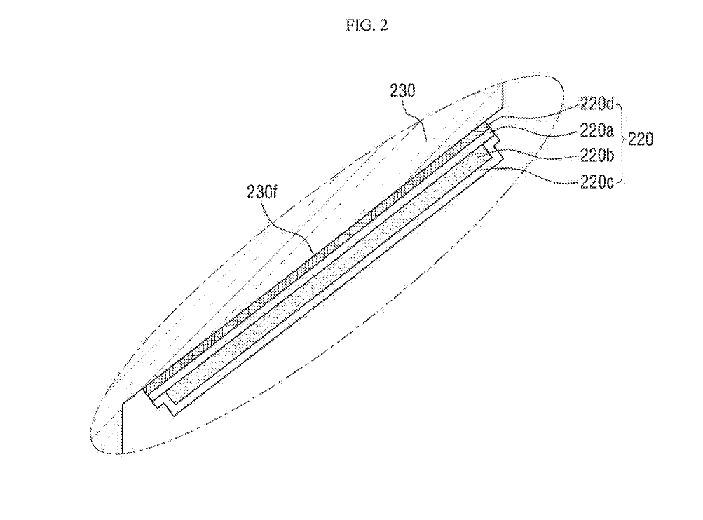

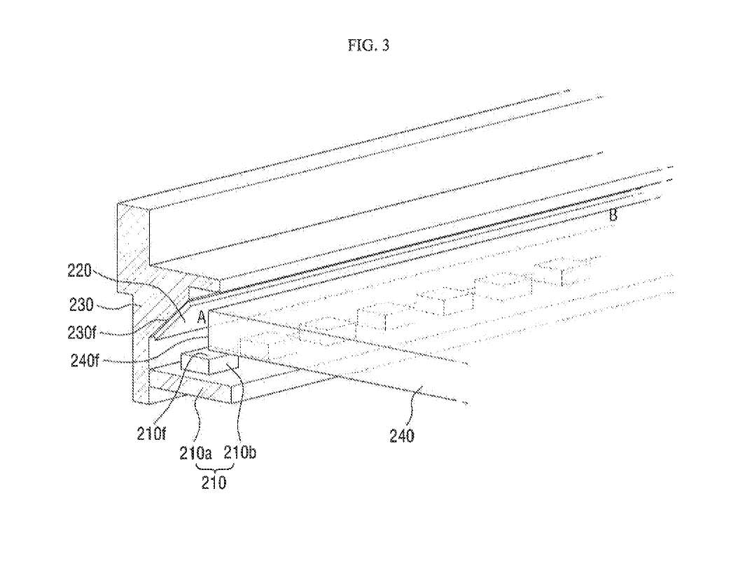

FIG. 1 is a cross-sectional view of a display device according to an exemplary embodiment of the present invention. FIG. 2 is an enlarged cross-sectional view of a portion II in FIG. 1, and FIG. 3 is a perspective view of a backlight assembly of the display device of FIG. 1. Referring to FIGS. 1 to 3, a display device according to an exemplary embodiment of the present invention includes a display panel 100 and a backlight assembly. The display device according to an exemplary embodiment of the present invention may include a polarizing plate 300, a top chassis 400, a bottom chassis 500, and a heat dissipation member 600.

The display panel 100 may display data. The display panel 100 may be a liquid crystal display (LCD) panel, an electrophoretic display panel, an organic light emitting display (OLED) panel, a light emitting diode (LED) panel, an inorganic electroluminescent (EL) display panel, a field emission display (FED) panel, a surface-conduction electron-emitter display (SED) panel, a plasma display panel (PDP), or a cathode ray tube (CRT) display panel, for example. Hereinafter, as a display device according to an exemplary embodiment of the present invention, an LCD may be described, and as a display panel 100, an LCD panel may be described. However, the display device and the display panel 100 according to the present invention are not limited thereto, and various types of display devices and display panels may be used.

The display panel 100 may include a display region where an image is displayed and a non-display region where an image is not displayed. The display panel 100 may include a first substrate 110, a second substrate 120 that faces the first substrate 110, and a liquid crystal layer (not illustrated) interposed between the first substrate 110 and the second substrate 120.

The first substrate 110 and the second substrate 120 may have a cuboidal shape, but are not limited thereto. The first substrate 110 and the second substrate 120 may have various shapes.

The liquid crystal layer may be interposed between the first substrate 110 and the second substrate 120. Between the first substrate 110 and the second substrate 120, a sealing member, such as a sealant, may be disposed along border portions of the first substrate 110 and the second substrate 120 to attach and seal the first substrate 110 and the second substrate 120.

The display panel 100 may include a driving portion and a flexible circuit board, which may be attached to the first substrate 110 or the second substrate 120. The driving portion may apply various signals, such as driving signals to display an image on the display region. The flexible circuit board may output various signals to the driving portion.

The backlight assembly may be disposed on a lower portion of the display panel 100. The backlight assembly may provide light to the display panel 100. The backlight assembly will be described in more detail below.

The polarizing plate 300 may be disposed on an upper surface and a lower surface of the display panel 100. The polarizing plate 300 may change the phase of light that passes through the display panel 100. The polarizing plate 300 may include a first polarizing plate 310 and a second polarizing plate 320. The first polarizing plate 310 may be attached to the lower surface of the first substrate 110, and the second polarizing plate 320 may be attached to the upper surface of the second substrate 120.

The top chassis 400 may cover a border of the display panel 100, and may surround a side surface of the backlight assembly. The bottom chassis 500 may accommodate the backlight assembly. The top chassis 400 and the bottom chassis 500 may include a conductive material, for example, a metal.

The heat dissipation member 600 may be interposed between the backlight assembly and the bottom chassis 500. The heat dissipation member 600 may include a material having a high thermal conductivity. The heat dissipation member 600 may support the backlight assembly and dissipate heat that is generated in the backlight assembly to an outside. The heat dissipation member 600 may be omitted.

Hereinafter, a backlight assembly according to an exemplary embodiment of the present invention will be described in more detail. The backlight assembly may include a light source portion 210, a wavelength conversion member 220, a mold frame 230, a light guide plate 240, a reflective plate 250 and an optical sheet 260.

The light source portion 210 may emit light that is provided to the display panel 100. The light source portion 210 may be disposed on a lower portion of the boarder of the display panel 100. In other words, the light source portion 210 may be disposed adjacent to the edge of the display panel 100. The backlight assembly according to an exemplary embodiment of the present invention may be an edge type backlight assembly that is disposed only in a region that is adjacent to the edge of the display panel 100.

The light source portion 210 may include a circuit board 210a and a light source 210b.

The circuit board 210a may be disposed on the light dissipation member 600 or the bottom chassis 500. The circuit board 210a may be disposed on a lower portion of the light guide plate 240. The circuit board 210a may be in direct contact with an upper surface of the heat dissipation member 600 and a side surface of the mold frame 230. The circuit board 210a may transfer a driving voltage from an external light source (not illustrated) to the light source 210b.

The light source 210b may be mounted on a surface of the circuit board 210a. The surface of the circuit board 210a may be parallel to the upper surface and the lower surface of the display panel 100. The light source 210b may receive a voltage from the circuit board 210a and may emit light that is provided to the display panel 100.

The light source 210b may be a Light Emitting Diode (LED), but is not limited thereto. The light source 210b may include various elements that can emit light. In an exemplary embodiment of the present invention, the light source 210b may be a blue LED that emits blue light.

Referring to FIG. 3, a plurality of light sources 210b may be provided. The plurality of light sources 210b may be spaced apart from each other. Gap distances between two adjacent light sources 210b may be equal to each other. The plurality of light sources 210b may be arranged in a line along a side portion of the light guide plate 240.

The light source 210b may include a light emission surface 210f for emitting light. The light emission surface 210f may be an upper surface of the light source 210b. In an exemplary embodiment of the present invention, the light emission surface 210f may be parallel to the upper surface and the lower surface of the display panel 100. In an exemplary embodiment of the present invention, the light emission surface 210f may be parallel to a surface of the circuit board 210a that comes in direct contact with the light source 210b.

The wavelength conversion member 220 may be disposed on an upper portion of the light source portion 210. In an exemplary embodiment of the present invention, the wavelength conversion member 220 may overlap the light source 210b and the light guide plate 240. The wavelength conversion member 220 may convert the wavelength of light emitted from the light source portion 210. The wavelength conversion member 220 may convert the color of the light emitted from the light source portion 210. For example, in the case where the light source portion 210 emits blue light, the wavelength conversion member 220 may convert the blue light into white light.

A surface of the wavelength conversion member 220 may form a predetermined angle θ with the light emission surface 210f of the light source 210b. In other words, one surface of the wavelength conversion member 220 need not be parallel to the light emission surface 210f of the light source 210b. In an exemplary embodiment of the present invention, a surface of the wavelength conversion member 220 may form an acute angle with the light emission surface 210f of the light source 210b. For example, a surface of the wavelength conversion member 220 may form an angle of about 20° to about 70° with the light emission surface 210f of the light source 210b. For example, one surface of the wavelength conversion member 220 may form an angle of about 45° with the light emission surface 210f of the light source 210b.

Referring to FIG. 2, the wavelength conversion member 220 may include a reflective layer 220a, a wavelength conversion layer 220b, a barrier layer 220c, and an adhesive layer 220d.

The reflective layer 220a may include a material that can reflect light. In an exemplary embodiment of the present invention, the reflective layer 220a may include a metal, but is not limited thereto. The reflective layer 220a may be formed by alternately stacking insulating materials having different refractive indexes or different metal oxides. The reflective layer 220a may redirect the light that is emitted from the light source portion 210. The reflective layer 220a may reflect the light, which is emitted from the light source portion 210 and travels upward, to travel in the direction of the light guide plate 240. On one surface of the reflective layer 220a, the wavelength conversion layer 220b may be disposed. A surface of the reflective layer 220a may face the light source portion 210 and the light guide plate 240. A surface of the reflective layer 220a may form the predetermined angle θ with the light emission surface 210f of the light source 210b. In other words, one surface of the reflective layer 220a need not be parallel to the light emission surface 210f of the light source 210b. In an exemplary embodiment of the present invention, a surface of the reflective layer 220a may form an acute angle with the light emission surface 210f of the light source 210b. For example, a surface of the reflective layer 220a may form an angle of about 20° to about 70° with the light emission surface 210f of the light source 210b.

The wavelength conversion layer 220b may be positioned on a surface of the reflective layer 220a. The wavelength conversion layer 220b may convert the wavelength of the light that is emitted from the light source portion 210. In an exemplary embodiment of the present invention, the wavelength conversion layer 220b may convert light having a relatively short wavelength into light having a relatively long wavelength. For example, if blue light is emitted from the light source portion 210, the wavelength conversion layer 220b may convert the blue light emitted from the light source portion 210 into white light.

The wavelength conversion layer 220b may include phosphor or quantum dots. The phosphor may include garnet series yellow phosphor, but is not limited thereto. The quantum dots may be quantum dots including a cadmium (Cd) compound, for example, CdSe, but are not limited thereto. The quantum dots may be quantum dots that do not include the cadmium compound, for example, InP. In an exemplary embodiment of the present invention, the wavelength conversion layer 220b may include yellow quantum dots that convert the wavelength of the incident light into the wavelength of yellow light. In an exemplary embodiment of the present invention, the wavelength conversion layer 220b may include two or more kinds of quantum dots. For example, the wavelength conversion layer 220b may include red quantum dots that convert the wavelength of the incident light into the wavelength of red light and green quantum dots that convert the wavelength of the incident light into the wavelength of green light.

The phosphor or the quantum dots included in the wavelength conversion layer 220b may be mixed with curable resin and may be spread on a surface of the reflective layer 220a. The spread wavelength conversion layer 220b may be cured by UV or heat and may be fixed to one surface of the reflective layer 220a, but is not limited thereto. The wavelength conversion layer 220b may be produced in a sheet form in a separate process and may be attached to the reflective layer 220a.

The barrier layer 220c may be positioned on the wavelength conversion layer 220b. The barrier layer 220c may entirely cover the wavelength conversion layer 220b. In other words, the barrier layer 220c may seal the wavelength conversion layer 220b together with the reflective layer 220a. The barrier layer 220c may protect the wavelength conversion layer 220b from external moisture or oxygen. The barrier layer 220c may include an insulating material. For example, the barrier layer 220c may include silicon oxide (SiOx), silicon nitride (SiNx), or a combination thereof.

The adhesive layer 220d may be interposed between the reflective layer 220a and the mold frame 230. The adhesive layer 220d may fix the reflective layer 220a, the wavelength conversion layer 220b, and the barrier layer 220c onto the mold frame 230. The adhesive layer 220d may include a known adhesive material.

The mold frame 230 may be positioned on the wavelength conversion member 220. Further, the mold frame 230 may be engaged with the top chassis 400 and the bottom chassis 500 to support the display panel 100. Further, the mold frame may fix the light source portion 210, the wavelength conversion member 220, the light guide plate 240, the reflective plate 250, and the optical sheet 260 onto the bottom chassis 500.

The mold frame 230 may include an inclined surface 230f. The inclined surface 230f may be positioned on the upper portion of the light source portion 210 and the side portion of the light guide plate 240. The inclined surface 230f may face the light source portion 210 and the light guide plate 240. The inclined surface 230f may form the predetermined angle θ with the light emission surface 210f of the light source 210b. In other words, the inclined surface 230f need not be parallel to the light emission surface 210f of the light source 210b. In an exemplary embodiment of the present invention, the inclined surface 230f may form an acute angle with the light emission surface 210f of the light source 210b. For example, the inclined surface 230f may form an angle of about 20° to about 70° with the light emission surface 210f of the light source 210b.

On the inclined surface 230f of the mold frame 230, the wavelength conversion member 220 as described above may be positioned. When the adhesive layer 220d of the wavelength conversion member 220 come in direct contact with the inclined surface 230f of the mold frame 230, the wavelength conversion member 220 may be fixed onto the inclined surface 230f of the mold frame 230.

The light guide plate 240 may be positioned on the side portion of the wavelength conversion member 220. In other words, the light guide plate 240 may be positioned on the inclined surface 230f of the mold frame 230. The light guide plate 240 may overlap the wavelength conversion member 220, but might not overlap the light source 210b of the light source portion 210b. The light guide plate 240 and the light source 210b may be arranged on different planes. The light guide plate 240 may be interposed between the display panel 100 and the bottom chassis 500. The light guide plate 240 may guide and transfer the light that is emitted from the light source portion 210 to the display panel 100.

The light guide plate 240 may include a transparent material. In an exemplary embodiment of the present invention, the light guide plate 240 may include polymethyl-methacrylate (PMMA), but is not limited thereto. The light guide plate 240 may include various transparent materials that can guide the light. The light guide plate 240 may include a rigid material, but is not limited thereto. The light guide plate 240 may include a flexible material. The light guide plate 240 may have a cuboidal plate shape, but is not limited thereto. The light guide plate 240 may be in various shapes.

The light guide plate 240 may include a light incident surface 240f to which the light that is emitted from the light source portion 210 is redirected. The light incident surface 240f of the light guide plate 240 may face the wavelength conversion member 220. The light incident surface 240f of the light guide plate 240 may be perpendicular to the light emission surface 210f of the light source portion 210. As described above, the light, which is emitted from the light source portion 210 and of which the wavelength may be converted by the wavelength conversion member 220, may be redirected to the inside of the light guide plate 240. The light that is redirected to the inside of the light guide plate 240 may be guided in the light guide plate 240, and then may be emitted through the upper surface of the light guide plate 240 to be transferred to the display panel 100.

The reflective plate 250 may be arranged on the lower side of the light guide plate 240. For example, the reflective plate 250 may be interposed between the light guide plate 240 and the heat dissipation member 600. The reflective plate 250 may change the path of the light that travels in the direction of the bottom chassis 500 in the light guide plate 240 to the direction of the display panel 100.

The optical sheet 260 may be arranged on the upper portion of the light guide plate 240. For example, the optical sheet 260 may be arranged between the display panel 100 and the light guide plate 240. The optical sheet 260 may modulate the optical characteristics of the light that is emitted through the upper surface of the light guide plate 240. A plurality of optical sheets 260 may be provided. The plurality of optical sheets 260 may have different functions. The plurality of optical sheets 260 may be stacked and overlap each other to supplement each other.

In the backlight assembly according to an exemplary embodiment of the present invention as described above, the wavelength conversion member 220 may convert the wavelength of the light that is emitted from the light source portion 210 to transfer the converted light to the light guide plate 240, and thus the color purity of the light that is transferred to the light guide plate 240 may be increased. For example, if the light source portion 210 includes a blue LED and the wavelength conversion member 220 includes quantum dots that convert the wavelength of the incident light into the wavelength of while light, a clear and uniform white light may be transferred to the light guide plate 240 due to high color reproduction of the quantum dots themselves.

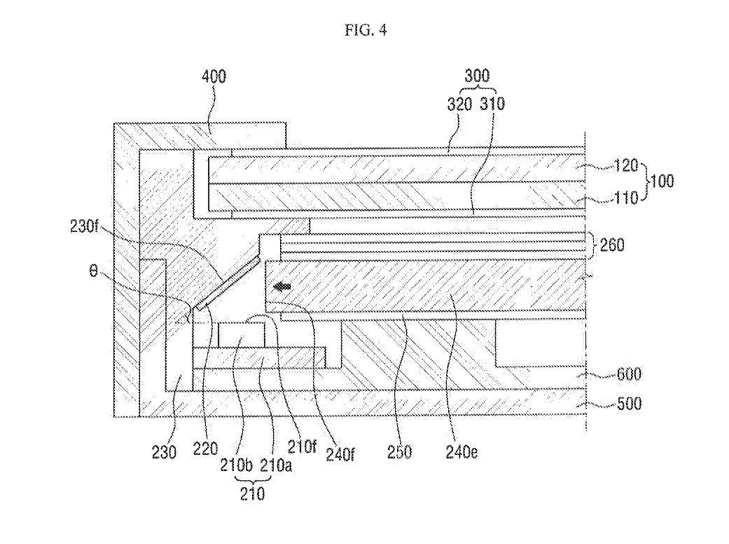

The backlight assembly according to an exemplary embodiment of the present invention might not have a horizontal light incident structure in which the light source portion 210, the wavelength conversion member 220, and the light guide plate 240 are arranged in a line, but may have a vertical light incident structure in which the wavelength conversion member 220 is positioned on the upper portion of the light source portion 210 and the light guide plate 240 is positioned on the side portion of the wavelength conversion member 220. In other words, the backlight assembly according to an exemplary embodiment of the present invention may secure a space that is surrounded by the light source portion 210, the wavelength conversion member 220, and the light guide plate 240. As shown in FIG. 4, when a light guide plate 240e is thermally expanded, the thermally expanded light guide plate 240e might not exert an influence on the light source portion 210 and the wavelength conversion member 220. In other words, damage to the wavelength conversion member 220 and the light source portion 210 due to the expansion of the light guide plate 240 may be prevented when the light incident structure that is arranged on the light incident surface 240f of the light guide plate 240 is omitted. Accordingly, a dark portion that may be generated on the light incident structure can be reduced.

When the wavelength conversion member 220 performs light guide function for transferring the light emitted from the light source portion 210 to the light guide plate 240, a separate guide member might not be needed. When a separate guide member is arranged on the light source portion 210, light leakage may occur between the guide member and the light source portion 210 or between the adjacent guide members. In contrast, in the backlight assembly according to an exemplary embodiment of the present invention, a guide member may be unnecessary, and thus the generation of the dark portion due to light leakage can be reduced.

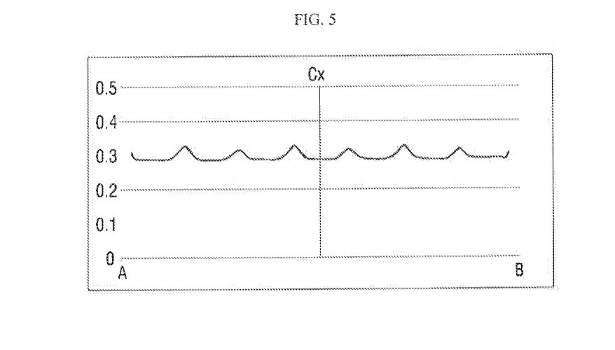

When a space in which lights are mixed is sufficiently secured while the light emitted from the light source unit 210 is redirected to the light guide plate 240 after being reflected from the wavelength conversion member 220, the uniformity of the light that is redirected to the light incident surface 240f of the light guide plate 240 may be increased. Graphs illustrating exemplary color coordinates when lights are mixed are illustrated in FIGS. 5 to 8. Referring to FIGS. 5 to 8, a color mixing function of the backlight assembly according to an exemplary embodiment of the present invention will be described in more detail. FIGS. 5 to 8 show exemplary color coordinates when using the light source portion 210 including a blue LED and the wavelength conversion member 220 including yellow phosphor.

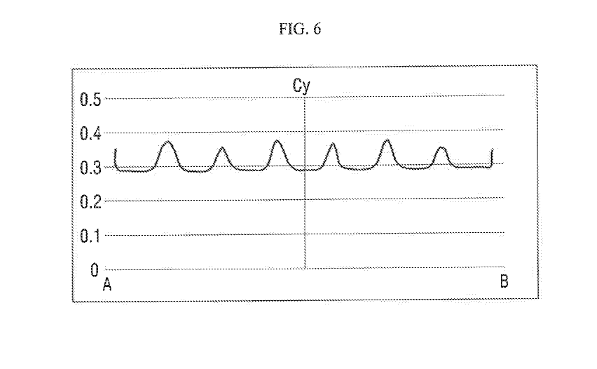

FIGS. 5 and 6 are graphs illustrating color coordinates in a portion A-B in the case where a horizontal light incident structure is applied to the backlight assembly of FIG. 3. FIGS. 5 and 6 show x color coordinates Cx and y color coordinates Cy in the portion A-B of the light incident surface 240f of the light guide plate 240 after the light source portion 210, the wavelength conversion member 220, and the light guide plate 240 are arranged in a line through changing of the positions of the light source portion 210 and the wavelength conversion member 220 of FIG. 3. Referring to FIGS. 5 and 6, it can be seen that both the x color coordinates Cx and the y color coordinates Cy are non-uniform in the portion A-B of the light guide plate 240. A portion having relatively low color coordinates is a front portion of the light source 210b which becomes bluish, and the portion having relatively high color coordinates is a portion between the adjacent light sources 210b which becomes yellowish. In other words, in the backlight assembly having the horizontal light incident structure, it may be difficult to secure color uniformity of the light that is transferred to the light guide plate 240.

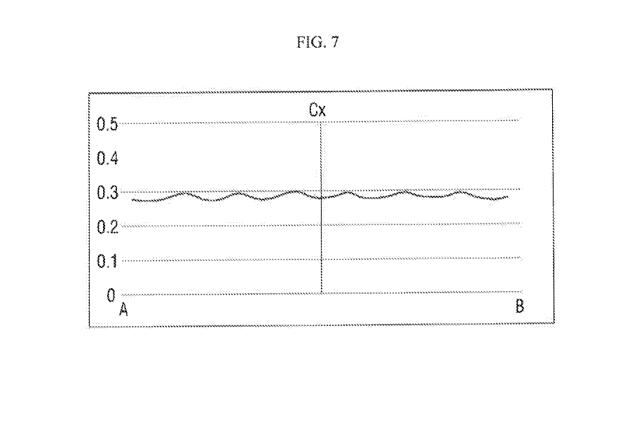

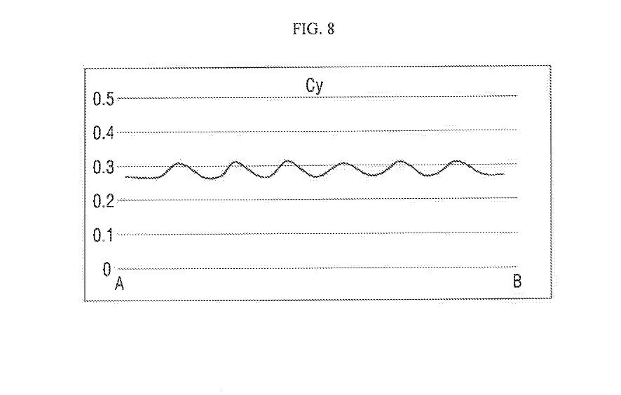

FIGS. 7 and 8 are graphs illustrating color coordinates in a portion A-B of FIG. 3. FIGS. 7 and 8 show x color coordinates Cx and y color coordinates Cy in the portion A-B of the light guide plate 240 in the backlight assembly having the vertical light incident structure according to an exemplary embodiment of the present invention. A surface of the wavelength conversion member 220 may form an angle of about 45° with the light emission surface 210f of the light source 210b. Referring to FIGS. 7 and 8, as compared with FIGS. 5 and 6, both the x color coordinates Cx and the y color coordinates Cy become more uniform in the portion A-B of the light guide plate 240. In other words, when the backlight assembly having the vertical light incident structure according to an exemplary embodiment of the present invention provides a space in which lights emitted from the light source portion 210 can be mixed, more uniform color light can be transmitted to the light guide plate 240.

In the backlight assembly according to an exemplary embodiment of the present invention, the light source portion 210 may come in direct contact with the heat dissipation member 600. The heat generated from the light source portion 210 may be discharged to an outside through the heat dissipation member 600 and the bottom chassis 500.

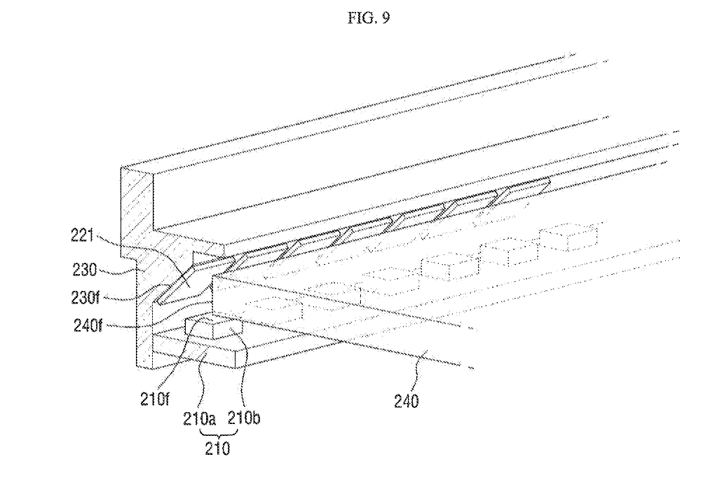

FIG. 9 is a perspective view of a backlight assembly of a display device according to an exemplary embodiment of the present invention. The same reference numerals in FIG. 9 may refer to substantially the same elements illustrated in the prior drawings, and thus a duplicate explanation thereof may be omitted.

Referring to FIG. 9, a wavelength conversion member 221 may be patterned. In other words, a plurality of wavelength conversion members 221 may be provided, and the plurality of wavelength conversion members 221 may correspond to the plurality of light sources 210b, respectively. In an exemplary embodiment of the present invention, the plurality of wavelength conversion members 221 may be respectively disposed on the plurality of light sources 210b. Accordingly, the light that is transferred to the light guide plate 240 can be adjusted to have higher color uniformity.

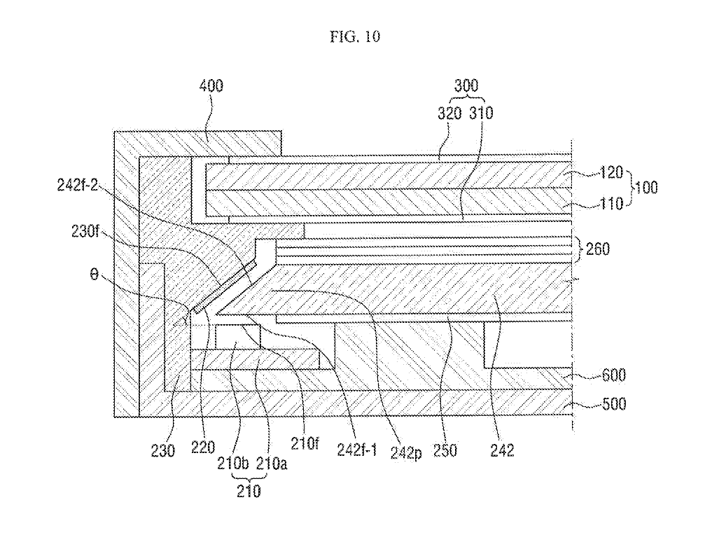

FIG. 10 is a cross-sectional view of a display device according to an exemplary embodiment of the present invention. The same reference numerals in FIG. 10 may refer to substantially the same elements illustrated in the prior drawings, and thus a duplicate explanation thereof may be omitted.

Referring to FIG. 10, a light guide plate 242 may include a projection portion 242p that projects in the direction of the wavelength conversion member 220. In other words, the projection portion 242p may partially fill the space between the wavelength conversion member 220 and the light source portion 210.

The projection portion 242p may include a first light incident surface 242f-1 and a second light incident surface 242f-2. The first light incident surface 242f-1 may be a lower surface of the projection portion 242p, and the second light incident surface 242f-2 may be an upper surface of the projection portion 242p. The first light incident surface 242f-1 may be substantially parallel to the light emission surface 210f of the light source portion 210, and the second light incident surface 242f-2 may be substantially parallel to a surface of the wavelength conversion member 220.

As described above, when the light guide plate 242 includes the projection portion 242p, the overall volume of the light guide plate 242 may be increased. Accordingly, the light guide function of the light guide plate 242 may be increased.

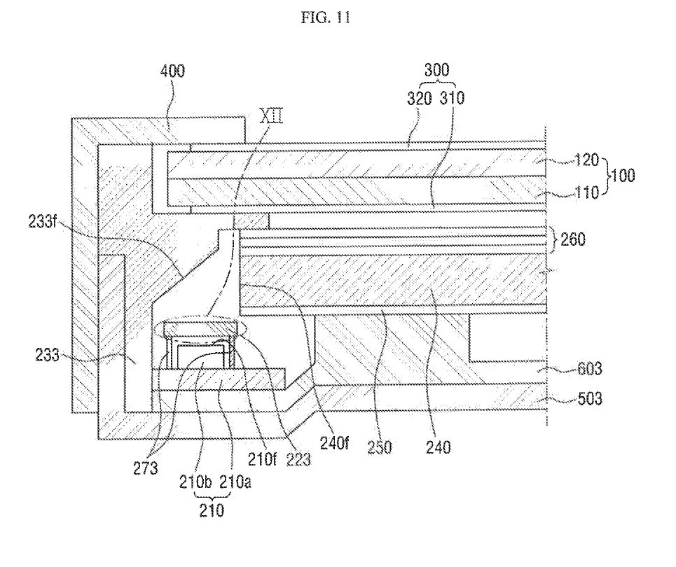

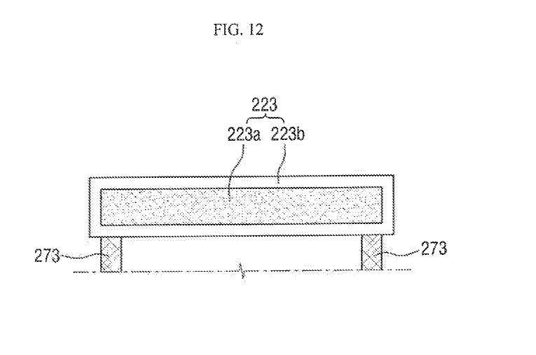

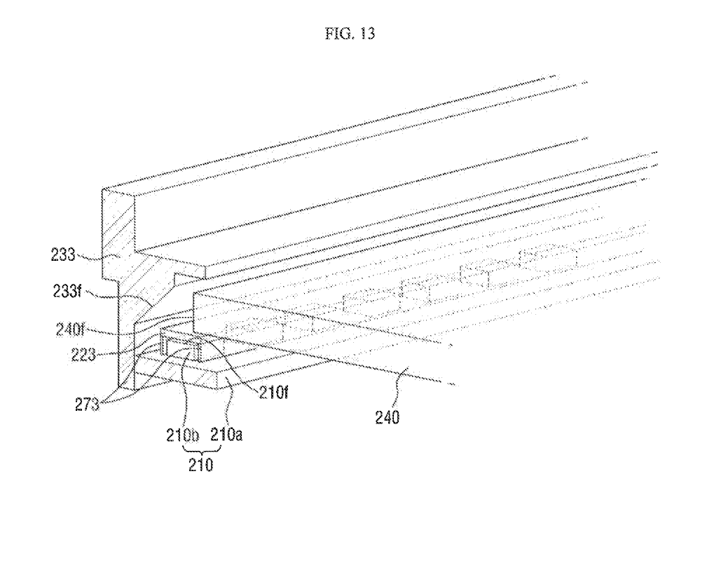

FIG. 11 is a cross-sectional view of a display device according to an exemplary embodiment of the present invention, FIG. 12 is an enlarged cross-sectional view of a portion XII in FIG. 11, and FIG. 13 is a perspective view of a backlight assembly of the display device of FIG. 11. The same reference numerals in FIG. 11 may refer to substantially the same elements illustrated in the prior drawings, and thus a duplicate explanation thereof may be omitted.

Referring to FIGS. 11 to 13, a wavelength conversion member 223 might not be attached to a mold frame 233, but may be fixedly arranged on the light source 210b of the light source portion 210 by a support 273. In other words, the wavelength conversion member 223 may be arranged between the mold frame 233 and the light source portion 210 and be spaced apart from the mold frame 233 and the light source portion 210, but is not limited thereto. The wavelength conversion member 223 may be in direct contact with the light source portion 210. The wavelength conversion member 223 may overlap the mold frame 233, but need not overlap the light guide plate 240.

The wavelength conversion member 223 may include a wavelength conversion layer 223a and a sealing member 223b.

The wavelength conversion layer 223a may be substantially the same as the wavelength conversion layer 220b described above. However, the density or thickness of the wavelength conversion layer 223a may be greater than the density or thickness of the wavelength conversion layer 220b described above.

The sealing member 223b may seal the wavelength conversion layer 223a. The sealing member 223b may include transparent glass, but is not limited thereto. The sealing member 223b may include a transparent insulating material, for example, silicon oxide (SiOx) or silicon nitride (SiNx). Like the above-described barrier layer 220c, the sealing member 223b may protect the wavelength conversion layer 223a from external moisture or oxygen.

The support 273 may fix the wavelength conversion member 223 onto the light source 210b. The support 273 may be in direct contact with the circuit board 210a of the light source portion 210 and the sealing member 223b of the wavelength conversion member 223 to fix the wavelength conversion member 223. The support 273 may be positioned on opposite side portions of the light source 210b to surround the light source 210b. The support 273 may include a reflective material and may perform a light guide function for reflecting the light emitted from the light source 210b toward an inclined surface 233f of a mold frame 233.

The mold frame 233 may include a reflective material. Accordingly, the light, which is emitted from the light source portion 210 and of which the wavelength is converted by the wavelength conversion member 223, may be reflected from the mold frame 233 in the direction of the light guide plate 240, but is not limited thereto. The mold frame 233 may include a non-reflective material, and a reflection coating may be disposed on the inclined surface 233f of the mold frame 233. The inclined surface 233f may have substantially the same inclination as the inclined surface 230f as described above.

When the wavelength conversion member 223 is not attached onto the mold frame 233, and is separately fixed onto the light source portion 210, a thickness of an edge portion of the display device may be increased. A bottom chassis 503 may include a recess portion in the edge portion to accommodate the increased thickness of the edge portion of the display device, and the heat dissipation member 603 may include a similar shape.

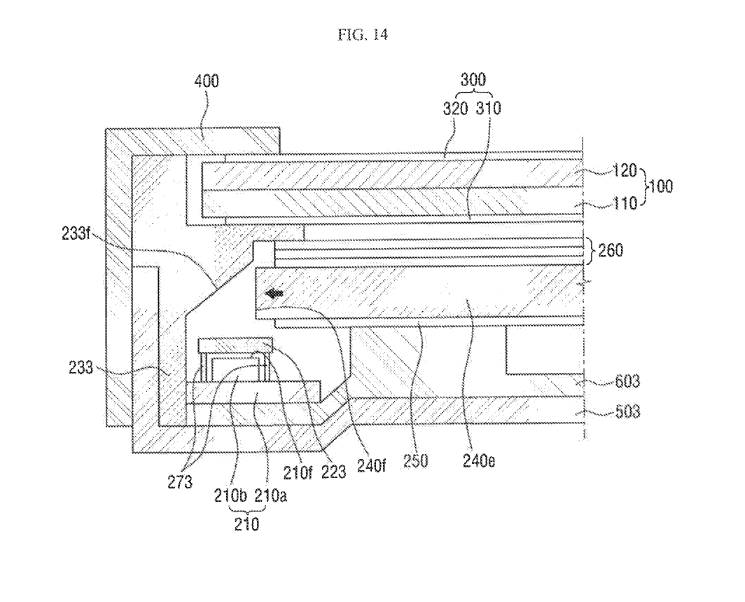

The backlight assembly according to an exemplary embodiment of the present invention may have substantially the same function as the backlight assembly according to an exemplary embodiment of the present invention as described above. For example, as shown in FIG. 14, when the light guide plate 240e is thermally expanded, the expanded light guide plate 240e might not come in contact with the wavelength conversion member 223 and the light source portion 210, and thus the wavelength conversion member 223 and the light source portion 210 can be stably maintained in the display device.

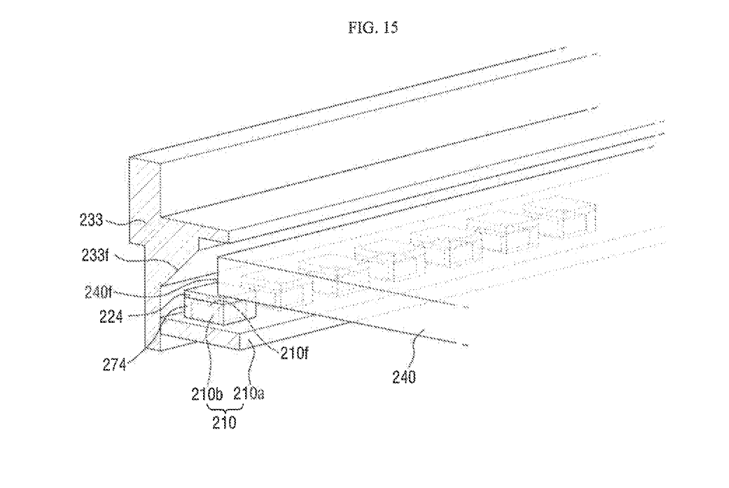

FIG. 15 is a perspective view of a backlight assembly of a display device according to an exemplary embodiment of the present invention. The same reference numerals in FIG. 15 may refer to substantially the same elements as illustrated in the prior drawings, and thus a duplicate explanation thereof may be omitted.

Referring to FIG. 15, a plurality of wavelength conversion members 224 may be provided, and the plurality of wavelength conversion members 224 may correspond to the plurality of light sources 210b. In an exemplary embodiment of the present invention, the plurality of wavelength conversion member 224 may be correspondingly disposed on the plurality of light sources 210b. Supports 274 may support the plurality of wavelength conversion members 224 and may completely surround four side surfaces of the light sources 210b. Accordingly, the light that is transferred to the light guide plate 240 can be adjusted to have higher color uniformity.

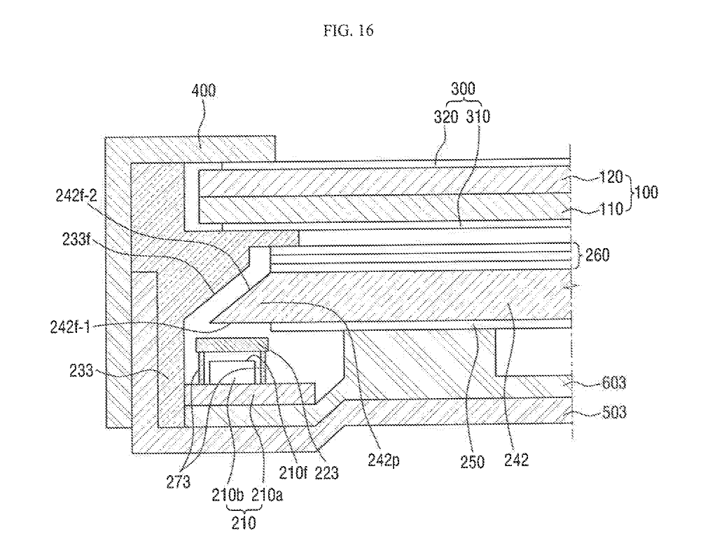

FIG. 16 is a cross-sectional view of a display device according to an exemplary embodiment of the present invention. The same reference numerals in FIG. 16 may refer to substantially the same elements as illustrated in the prior drawings, and thus a duplicate explanation thereof may be omitted.

Referring to FIG. 16, a light guide plate 242 may include a projection portion 242p that projects in the direction of the mold frame 233. The projection portion 242p may partially fill the space between the mold frame 233 and the wavelength conversion member 223. As described above, the projection portion 242p may include a first light incident surface 242f-1 and a second light incident surface 242f-2. The first light incident surface 242f-1 may be substantially parallel to the light emission surface 210f of the light source portion 210 and the upper surface of the wavelength conversion member 223, and the second light incident surface 242f-2 may be substantially parallel to the inclined surface 233f of the mold frame 233.

As described above, when the light guide plate 242 includes the projection portion 242p, the overall volume of the light guide plate 242 may be increased. Accordingly, the light guide function of the light guide plate 242 may be increased.

While the present invention has been particularly shown and described with reference to exemplary embodiments thereof, it will be understood by those of ordinary skill in the art that various changes in form and detail may be made therein without departing from the spirit and scope of the present invention, as defined by the following claims.

What is claimed is:

1. A backlight assembly, comprising:
a light source portion configured to emit light;
a wavelength conversion member disposed on an upper portion of the light source portion, wherein the wavelength conversion member is configured to convert a wavelength of the light emitted from the light source portion; and
a light guide plate disposed on a side portion of the wavelength conversion member, wherein the light guide plate is configured to receive wavelength-converted light from the wavelength conversion member.

2. The backlight assembly of claim 1, wherein the wavelength conversion member comprises quantum dots.

3. The backlight assembly of claim 1, wherein the wavelength conversion member comprises:
a reflective layer configured to reflect the light emitted from the light source portion in a direction of the light guide plate; and
a wavelength conversion layer disposed on a surface of the reflective layer,
wherein the surface of the reflective layer faces the light source portion and the light guide plate.

4. The backlight assembly of claim 3, wherein the surface of the reflective layer forms an angle with a light emission surface of the light source portion.

5. The backlight assembly of claim 4, wherein the angle is about 20° to about 70°.

6. The backlight assembly of claim 1, further comprising a mold frame disposed on an upper portion of the wavelength conversion member, wherein the mold frame comprises an inclined surface that forms an angle with a light emission surface of the light source portion, and
wherein the wavelength conversion member is disposed on the inclined surface.

7. The backlight assembly of claim 1, wherein the light source portion comprises a plurality of light sources that are spaced apart from each other, and
a plurality of wavelength conversion members respectively correspond to the plurality of light sources.

8. The backlight assembly of claim 1, wherein the light guide plate comprises a projection portion projecting in a direction of the wavelength conversion member.

9. The backlight assembly of claim 8, wherein an upper surface of the projection portion is substantially parallel to a surface of the wavelength conversion member, and
a lower surface of the projection portion is substantially parallel to a light emission surface of the light source portion.

10. A backlight assembly, comprising:
a light source portion configured to emit light;
a wavelength conversion member disposed on an upper portion of the light source portion, wherein the wavelength conversion member is configured to convert a wavelength of the light emitted from the light source portion;
a mold frame disposed on an upper portion of the wavelength conversion member, wherein the mold frame is configured to reflect the wavelength converted light from the wavelength conversion member; and
a light guide plate disposed on a side portion of the mold frame, wherein the light guide plate is configured to receive the light reflected by the mold frame.

11. The backlight assembly of claim 10, wherein the wavelength conversion member comprises:
a wavelength conversion layer including quantum dots; and
a sealing member sealing the wavelength conversion layer.

12. The backlight assembly of claim 10, further comprising a support disposed between the light source portion and the wavelength conversion member, wherein the support is configured to fix the wavelength conversion member.

13. The backlight assembly of claim 12, wherein the light source portion comprises a circuit board and a light source positioned on the circuit board, and
the support surrounds the light source.

14. The backlight assembly of claim 10, wherein the mold frame comprises an inclined surface that forms a, angle with a light emission surface of the light source portion, and
the inclined surface is disposed on the upper portion of the wavelength conversion member and a side portion of the light guide plate.

15. The backlight assembly of claim 14, wherein the angle is about 20° to about 70°.

16. The backlight assembly of claim 10, wherein the light source portion comprises a plurality of light sources that are spaced apart from each other, and a plurality of wavelength conversion members respectively correspond to the plurality of light sources.

17. The backlight assembly of claim 10, wherein the light guide plate comprises a projection portion projecting in a direction of the mold frame.

18. A display device, comprising:
a display panel configured to display an image; and
a backlight assembly configured to provide light to the display panel,
wherein the backlight assembly includes:
a light source portion configured to emit light;
a wavelength conversion member disposed on an upper portion of the light source portion, wherein the wavelength conversion member is configured to convert a wavelength of the light emitted from the light source portion; and
a light guide plate disposed on a side portion of the wavelength conversion member, wherein the light guide plate is configured to receive the wavelength-converted light from the wavelength conversion member.

19. The display device of claim 18, wherein the wavelength conversion member comprises quantum dots.

20. The display device of claim 18, wherein the wavelength conversion member comprises:
a reflective layer configured to reflect the light emitted from the light source portion in a direction of the light guide plate; and
a wavelength conversion layer disposed on a surface of the reflective layer,
wherein the surface of the reflective layer faces the light source portion and the light guide plate.

21-25. (canceled)
